(19) United States
(12) Patent Application Publication
(10) Pub. No.: US 2012/0142795 A1
(43) Pub. Date: Jun. 7, 2012

(54) HIERARCHICAL THERMOPLASTIC SURFACE TEXTURES FORMED BY PHASE TRANSFORMATION AND METHODS OF MAKING

(75) Inventors: Kripa K. Varanasi, Lexington, MA (US); Adam T. Paxson, Cambridge, MA (US); Katherine M. Smyth, Boston, MA (US); Yuehua Cui, Boston, MA (US)

(73) Assignee: Massachusetts Institute of Technology, Cambridge, MA (US)

(21) Appl. No.: 12/960,611

(22) Filed: Dec. 6, 2010

(51) Int. Cl. C08J 9/00; C08G 63/00; C08G 64/06; B82Y 30/00

(52) U.S. Cl. 521/87; 521/189; 521/182; 521/98; 977/773; 977/788; 977/832

(57) ABSTRACT

Method for treating thermoplastic to make a surface thereof superhydrophobic. The method includes exposing the thermoplastic to a specific solvent for a selected time period. It is preferred that the treatment time be in the range of one minute to approximately five hours and more preferably in the range of one minute to 15 minutes. Thermoplastics and solvents having a similar solubility parameter interact with one another to form hydrophobic hierarchical surfaces.

### BACKGROUND OF THE INVENTION

This invention relates to hierarchical textured surfaces and more particularly to a textured superhydrophobic thermoplastic surface obtained by one-step, solvent-induced crystallization.

Superscript numbers refer to the references included herewith. The contents of all of these references are incorporated herein by reference in their entirety.

Superhydrophobic surfaces are widely present in nature. Examples include the lotus leaf that can self-clean¹ and the water strider insect that can rest on water using water-repellent legs². Another example is the desert beetle that can collect water by hydrophilic and hydrophobic surfaces in desert wind³. These natural superhydrophobic surfaces have led scientists to try to these surfaces so as to produce surfaces having different wetting ability for application in a large range of manufacturing, industrial, agricultural, and household settings⁴⁻⁵. A superhydrophobic surface is generally characterized by having a high advancing contact angle, above 150 degrees, low hysteresis angle, and easy roll-off⁶⁻⁷. It is known that water may contact superhydrophobic surfaces in two different states: the Wenzel state and the Cassie-Baxter state. In the Wenzel state, water droplets become pinned to the surface even when the surface is tilted. In contrast, in the Cassie-Baxter state, water droplets sit partially on surface air pockets and roll off easily on a tilted surface. Experiments involving the impact of water droplets on a surface provide additional information concerning surface wetting ability.⁸

It is also well known that the superhydrophobicity of a surface is primarily determined by its surface chemical composition and roughness⁹. The roughness tends to amplify the intrinsic wettability of a surface, such that an intrinsically hydrophobic surface becomes superhydrophobic, and an intrinsically hydrophilic surface becomes superhydrophilic. Superhydrophobic surfaces are often created by coating organic compounds such as fluorocarbon¹⁰ or polymer¹¹ on the rough surface of a silicon nanorod¹², on nanowires¹⁰, on metal oxides^{8, 13}, on alloys¹⁴, on nanotubes¹⁵ or on precious metals⁹ to produce the surfaces. These processes, however, are generally relatively complicated and often involve noble metals, long deposition times, high vacuum environments, and are environmentally unfriendly due to the use of acids. These processes often use delicate materials that hamper scaling up to industrial production levels.

Thermoplastics, however, are relatively inexpensive engineering materials that have seen prolific application on industrial scales. These polymers include polyester and polycarbonate, often referred to by the trade name Lexan. Polycarbonate is widely used for electronic components, in the construction industry, for data storage, for automotive and aircraft components, and in medical applications. Polycarbonate, polyester, and other thermoplastics show only a medium level of hydrophobicity. An object of the present invention is the production of superhydrophobic thermoplastic surfaces by a one-step solvent treatment. The solvent treatment results in superhydrophobic thermoplastic surfaces resulting from the formation of rough, hierarchical nano-scale crystal surfaces.

### SUMMARY OF THE INVENTION

The main aspect of the invention is a textured thermoplastic surface obtained by phase transformation resulting from a combination of thermal, pressure, and chemical treatment. In a preferred embodiment, the thermoplastic is exposed to an appropriate solvent for a time period in the range of approximately one minute to approximately five hours. A particularly preferred embodiment exposes polycarbonate to acetone for a time period in the range of 15 minutes. The thermoplastic may be in the form of sheets, films, microparticles or nanoparticles. In a preferred embodiment, the thermoplastic is dried at room temperature after the solvent treatment.

In another aspect, the invention is a method for treating a thermoplastic to make a surface thereof superhydrophobic by exposing the thermoplastic to a solvent for a selected time period to create hydrophobic hierarchical surfaces. It is preferred that the thermoplastic and solvent are selected to have similar solubility parameters.

### BRIEF DESCRIPTION OF THE DRAWING

FIGS. 1A and 1B are photographs of a static water droplet on untreated polycarbonate in FIG. 1A and on a superhydrophobic polycarbonate surface having been treated with acetone for 30 minutes.

FIGS. 2A-P are scanning electron microscope (SEM) images of a polycarbonate surface treated with acetone for different periods of time.

FIG. 3 is a graph illustrating the crystallization percentages of polycarbonate treated with acetone and calculated based on XRD patterns (insert) at different acetone treatment times.

FIG. 4 is a graph showing static advancing contact angles and receding contact angles of water on a polycarbonate surface treated by acetone for different times and dynamic roll-off angles of a water droplet on a polycarbonate surface treated by acetone for different time periods. Error bars show the average of three or four independent experiments.

FIGS. 5A-C are photographs of a time sequence of images of a water droplet free falling on an untreated polycarbonate surface in FIG. 5A, on a polycarbonate surface treated by acetone for 1 minute in FIG. 5B on a polycarbonate surface treated by acetone for 15 minutes in FIG. 5C.

FIGS. 6 A-B are photomicrographs of a polycarbonate surface treated with dichloromethane (FIG. 6A) and a polyester surface treated with acetone (FIG. 6B).

### DESCRIPTION OF THE PREFERRED EMBODIMENT

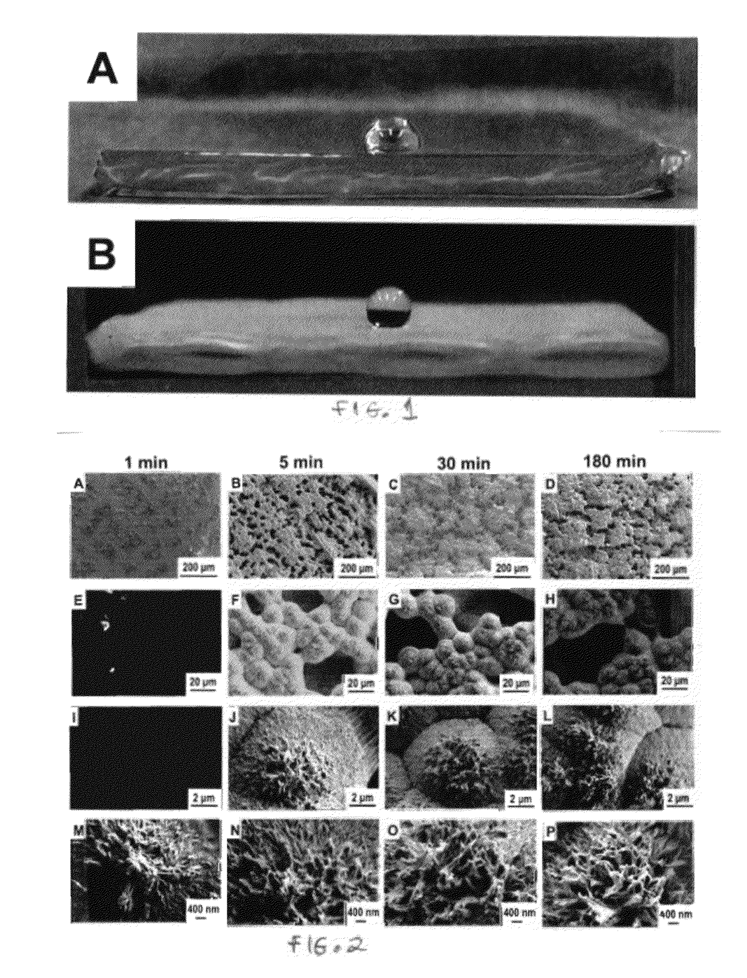

Polycarbonate is a transparent polymer comprising monomers containing hydrophobic phenyl and methyl groups and a hydrophilic carbonate group. Scanning electron microscope images of untreated polycarbonate show a smooth surface that exhibits medium hydrophobicity to a static water droplet on its surface. See FIG. 1A. Based on the chemical composition of the polycarbonate monomer, acetone, (CH₃)₂CO, was chosen to treat polycarbonate to obtain a superhydrophobic surface by rearrangement of the polycarbonate macromolecules. The polycarbonate was immersed in acetone thr different time periods, and then taken out and dried at room temperature. The surface of the polycarbonate changed from transparent to white in color and exhibited superhydrophobicity. See FIG. 1B.

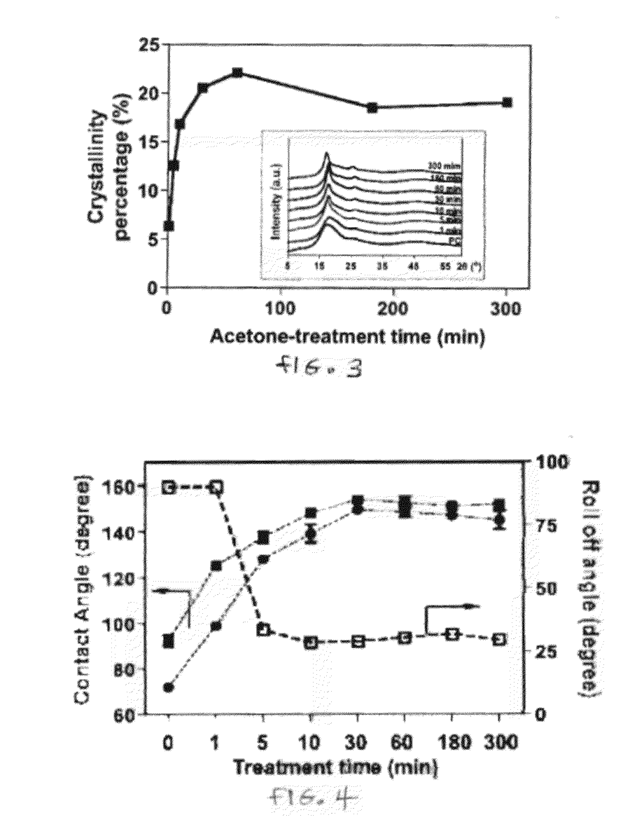

As much research has shown, superhydrophobicity results from rough and porous surface structures,¹⁶⁻¹⁸ that can efficiently trap air below a water droplet to separate liquid and solid 125 phases. After treatment with acetone, the polycarbonate surface exhibited layers and pores as shown in FIGS. 2B-D, spherulites as shown in FIGS. 2E-L and nano-fiber structures as shown in FIGS. 2M-P at different scales in the SEM images. As shown in FIG. 2A, partial spherulites formed on the polycarbonate surface after a one minute treatment with acetone followed by the formation of a hierarchical porous structure after five minutes as shown in FIGS. 2B-D. Multiple layers were observed with increasing treatment times as shown in FIGS. 2F-H. The hierarchical structures were comprised of spherulites with rough surfaces as shown in FIGS. 2E-L. The spherulites' diameter increased from approximately 3-4 μm in FIG. 2I to 6-10 μm in FIGS. 2J-L. Nano-fiber structures were also observed on the surface of these spherulites at the first layer in all of the treated polycarbonate as shown in FIGS. 2M-P. The fiber structures and fiber diameters were substantially unchanged with acetone treatment time. These pores, rough structures and fibers on the treated polycarbonate surface may trap air to produce superhydrophobicity.

The loss of transparency of the polycarbonate polymer suggests a crystallization of the polymer.¹⁹ The formation of hierarchical structures and the observation of a white color on the polycarbonate surface after acetone treatment suggested that the polycarbonate structure is changed after the acetone treatment. The polycarbonate structures that were treated for different times were analyzed by X-ray diffraction (XRD) as shown in FIG. 3. Untreated polycarbonate with a broad peak at approximately 18 degrees indicates an amorphous structure for the polycarbonate. With increasing acetone treatment time, the peak at 18 degrees became sharper and other peaks also formed suggesting the formation of crystal structures. The degree of crystallinity of samples was quantitatively estimated following the method of Nara and Komiya²⁰. The equation of the degree of crystallinity is; X_{c}=A_{c}/(A_{c}+Aₐ) where X_{c} refers to the degree of crystallinity, A_{c} refers to the crystallized area on an X-ray diffractogram and Aₐ refers to the amorphous area on the X-ray diffractogram. The degree of crystallinity increased with treatment time and reached the highest at approximately 30 minutes and then became stable as shown in FIG. 3.

The contact angles of water on the polycarbonate surface treated by acetone for different times were determined as shown in the left scales of FIG. 4. The advancing and receding angles increased with increasing treatment time. After treatment for approximately 30 minutes, the contact angles became stable, up to 150 degrees for advancing angle and 140 degrees for the receding angle. The superhydrophobicity results from the formation of layers, rough spherulites, and the nano-fiber flower structures on the polycarbonate surface.

The differences between advancing and receding angles were calculated as about 23 degrees for the polycarbonate treated by acetone for zero or one minute and ware decreased to about 4-9 degrees for treatments for a longer time. These results suggest that water contacts the polycarbonate surface in a Wenzel state for a one-minute treatment and changes to a Cassie-Baxter state for longer treatment periods. With reference to FIGS. 2A and 2E, the SEM images of the polycarbonate surface treated for one minute show that the percentage of spherulites on the surface is low, thereby permitting water completely to contact the surface without the presence of spherulites (Wenzel state). For polycarbonate treated for a longer time, however, all of the surfaces were covered by layers and spherulites which can trap air on the surface leading to the Cassie-Baxter state. The crystallization of the polycarbonate produced regular spherulite roughness that changes the polycarbonate surface from hydrophobic to superhydrophobic. The change is explained by a transition from the Wenzel state to the Cassie-Baxter state.

As shown in the right scales of FIG. 4, the adhesion of a water droplet to the polycarbonate surface was studied further by directly determining roil-off angles. A free six μL water droplet placed on the surface of untreated polycarbonate or polycarbonate treated with acetone for one minute remained attached to the surface and did not slide off when the substrate was tilted up to 90 degrees. With increasing treatment time, roll-off angles were decreased to about 30 degrees. The differences between advancing and receding angles were also decreased for longer treatment periods. The SEM images show that the untreated and one-minute treated polycarbonate did not produce as many hierarchical structures (pores and spherulites) on the surface as compared to polycarbonate treated for longer times.

We were also interested in the dynamic behavior of water on acetone-treated polycarbonate. On a macroscopic level, we compared the behavior of a water droplet freefalling onto an untreated polycarbonate surface and onto an acetone-treated polycarbonate surface. The photographs shown in FIG. 5 were captured using a high-speed camera at a 10,000 Hz frame rate. A water droplet falling onto the untreated polycarbonate surface did not rebound as shown in FIG. 5A suggesting that the surface shows a strong adhesion for water. Similar behavior is seen in FIG. 5B, where a sample treated for 1 minute exhibits high adhesion. As shown in FIG. 5C, the polycarbonate surface treated with acetone for 15 minutes shows a significantly different behavior. The water droplet recoiled multiple times from the surface on the acetone-treated polycarbonate. These impact experiments, contact angles, and roll-off angles are all in good agreement.

Based on our polycarbonate/acetone research and also on theories of a solubility parameter^{21, 22} solvent induced crystallization²³⁻²⁵ and solvent evaporation,^{26, 27} we disclose a one-step method for treating thermoplastics with solvents to produce hierarchical micro/nano polymer surfaces having selected hydrophobic characteristics. This aspect of the invention can be thought of as having two parts: (1) polymer/solvent selection, and (2) crystallization and hierarchical surface formation. Polymers and solvents are selected to have similar solubility parameters that indicate a strong interaction to induce a homogeneous solid. A homogeneous solid results from immersing the polymer in the solvent followed by solvent evaporation that further induces crystallization and hierarchical surface formation.

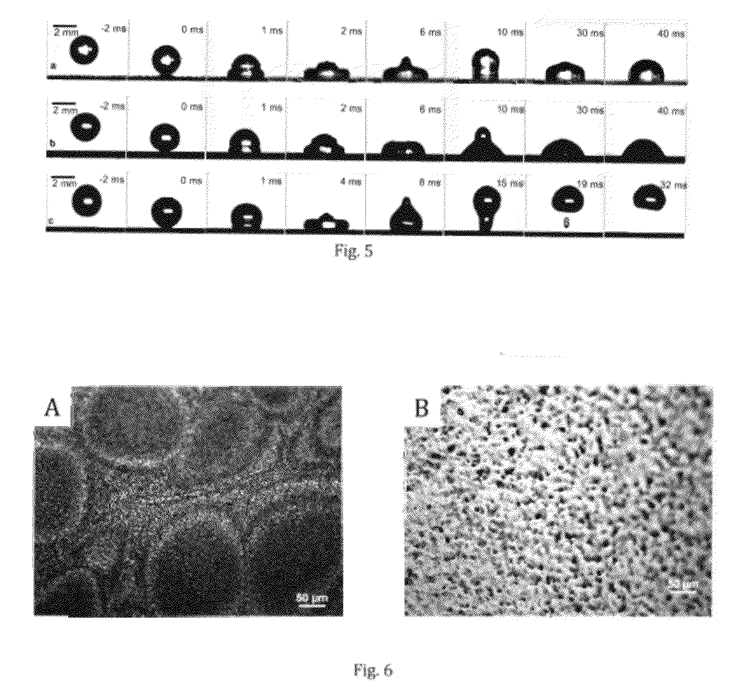

We used this method to create hierarchical surfaces in smooth polycarbonate (FIG. 6A) treated with dichloromethane to form nano-micro pores on the surface (FIG. 69). We also treated polyester (FIG. 6C) with acetone to create hierarchical structures (FIG. 6D).

It is recognized that modifications and variations of the present invention will be apparent to those of ordinary skill in the art and it is intended that all such modifications and variations be included within the scope of the appended claims.

### REFERENCES

(1) Wang, R.; Hashimoto, K.; Fujishima, A.; Chikuni, M.; Kojima, E.; Kitamura, A.; Shimohigoshi, M.; Watanabe, T. Nature 1997, 388, 431-432.
(2) Gao, X.-F.; Jiang, L. Nature 2004, 432, 36.
(3) Parker, A, R.; Lawrence, C. R. Nature 2001, 414, 33-34.
(4) Bhushan, B.; Koch, K.; Jung, Y. C. Appl. Phys. Lett. 2008, 93, 093101.
(5) Brozell, A. M.; Muha, M. A.; Abed-Amoli, A.; Bricarello, D.; Parikh, A. N. Nano Lett. 2007, 7, 3822-3826.
(6) Chen, W.; Fadeev, A. Y.; Hsieh, M. C.; Oner, D.; Youngblood, J.; McCarthy, T. J. Langmuir 1999, 15, 3395-3399.
(7) Oner, D.; McCarthy, T. J. Langmuir 2000, 16, 7777-7787.
(8) Deng, T.; Varanasi, K. K.; Hsu, M.; Bhate, N.; Keimel, C.; Stein, J.; Blohm, M. Appl. Phys, Lett. 2009, 94, 133109.
(9) Love, C. J.; Gates, B. D.; Wolfe, D. B.; Paul, K. E.; Whitesides, G. M. Nano lett. 2002, 2, 891-894.
(10) Verplanck, N.; Galopin, E.; Camart, J.-C.; Thorny, V. Nano Lett. 2007, 7, 813-817.
(11) Zhai, L.; Cebeci, F. C.; Cohen, R. E.; Rubner, M. F. Nano lett. 2004, 4, 1349-1353.
(12) Fan, J.-G.; Dyer, D.; Zhang, G.; Zhao, Y.-P. Nano Lett. 2004, 4, 2133-2138.
(13) Zheng, Y.-M.; Jiang, L.; Wang, J.-X.; Han, D. Appl. Phys. Lett. 2008, 93, 094197.
(14) Liu, K.; Zhang, M.-L.; Zhai, J.; Wang, J.; Jiang, L. Appl. Phys. Lett. 2008, 92, 183103.
(15) Lau, K. K. S.; Bico, J.; Teo, K. B. K.; Chhowalla, M.; Amaratunga, G. A. J.; Milne, W. I.; McKinley, G. H.; Gleason, K. K. Nano Lett. 2003, 3, 1701-1705.
(16) Feng, X. J. Jiang, L. Adv. Mater, 2006, 18, 3063-3078.
(17) Lafuma, A.; Quéré, Nat. Mater. 2003, 2, 457-460.
(18) Blossey, Nat. Mater 2003, 2, 301-306.
(19) Brady, D. G. J. Appl. Poly. Sci. 1976, 20, 2541-2551.
(20) Nara, S.; Komiya, T. Starch 1983, 35: 407-410.
(21) Marcus, Y. Chem. Soc. Rev. 1993, 409-416.
(22) Dïnç, C. Ö.; Kïbarer G.; Güner A. J. Appl. Poly. Sci. 2010, 117, 1100-1119.
(23) Turska, E.; Benecki, W.; J. Appl. Poly. Sci. 1979, 23, 3489-3500.
(24) Turska, E.; Janeczek, H.; Polymer 1979, 20, 855-858.
(25) Durning, C. J.; Rebenfeld, L.; Russel, W. B.; Weigmann, H. D.; J. Poly. Sci. Part B: Poly. Phys. 1986, 24, 1341-1360.
(26) Yang, Y. Y.; Chung T. S.; Ng N. P. Biomaterials 2001, 22, 231-241.
(27) Ge X.; Wang M.; Ji X.; Ge X.; Liu H. Colloid Poly. Sci. 2009, 287, 819-827.

What is claimed is:

1. An article comprising a thermoplastic surface with hierarchical texture obtained via phase transformation.

2. The article of claim 1 wherein the phase transformation is induced by a combination of one or more of thermal, pressure, and solvent effects.

3. The article of claim 1 whereby the phase transformation is solvent induced crystallization.

4. The article of claim 3 wherein the solubility parameter of the solvent is within 5 J^{1/2} cm^{-3/2} that of the thermoplastic.

5. The article of claim 1 wherein the hierarchical texture significantly alters the wettability as compared to the untextured thermoplastic.

6. The article of claim 5 wherein a hydrophobic thermoplastic is transformed into a superhydrophobic thermoplastic.

7. The article of claim 5 wherein a hydrophilic thermoplastic is transformed into a superhydrophilic thermoplastic.

8. The article of claim 3 wherein the thermoplastic is exposed to the solvent for a time period in the range of approximately one minute to approximately five hours.

9. The article of claim 8 wherein the time period is one minute to one hour.

10. The article of claim 1 wherein the thermoplastic is in the form of sheets, films, microparticles, or nanoparticles.

11. The article of claim wherein the thermoplastic is in the form of pre-roughened sheets or films.

12. The article of claim 8 further including drying the thermoplastic after treatment with solvent.

13. Method for treating a thermoplastic to make a surface thereof superhydrophobic comprising exposing the thermoplastic to a solvent for a selected time period to create hydrophobic hierarchical surfaces.

14. The method of claim 13 wherein the thermoplastic is polycarbonate and the solvent is acetone.

15. The method of claim 13 wherein the thermoplastic is polycarbonate and the solvent is dichloromethane.

16. The method of claim 13 wherein the thermoplastic is polyester and the solvent is acetone.
